(19) United States
(12) Patent Application Publication
(10) Pub. No.: US 2021/0039275 A1
(43) Pub. Date: Feb. 11, 2021

(54) PRODUCE SLICING MACHINE

(71) Applicants: HMC Fresh Foods, LLC., Kingsburg, CA (US); Heinzen LLC., Gilroy, CA (US)

(72) Inventors: William Casey Mount, Clovis, CA (US); David Martell Zamzow, Hollister, CA (US)

(21) Appl. No.: 16/682,777

(22) Filed: Nov. 13, 2019

Related U.S. Application Data
(60) Provisional application No. 62/885,108, filed on Aug. 9, 2019.

(51) Int. Cl. B26F 3/00; B26D 7/06; B26D 7/01

(52) U.S. Cl. CPC B26F 3/004; B26D 2210/02; B26D 7/018; B26D 7/0625

(57) ABSTRACT

A slicing machine for cutting agricultural produce items includes a conveyor plenum with a plenum top plate formed with many vacuum ports arranged in a longitudinal direction below the gap between conveyor belts in a dual-belt conveyor, a water jet knife positioned to emit a stream of high-pressure water between the individual belts in the dual belt conveyor with enough force to cut a produce item into separate pieces, and a belt shaker configured to strike the dual-belt conveyor at cyclical intervals.

### FIELD OF THE INVENTION

Embodiments are generally related to food processing machinery and more specifically to machinery for cutting into pieces previously harvested agricultural produce.

### BACKGROUND

A substantial, well-known risk of airway obstruction is associated with the consumption of small, rounded fruits and vegetables such as grapes, cherries, cherry tomatoes, olives, and the like. These food items have an approximately spherical or ellipsoidal shape with a small cross-sectional diameter and a soft, conforming surface that can deform and block a person's airway sufficiently to interfere with respiration, potentially leading to a medical emergency. The risk of airway obstruction is particularly high for young children because of their small airways, incompletely developed dentition, sometimes poor coordination of swallowing and breathing, and tendency to become distracted while eating. Elderly adults share some of the same risk factors with young children. Almost everyone has some level of risk of airway obstruction when eating small, soft, rounded food items.

Medical organizations and government agencies have recommended cutting grapes and other similar food items into pieces before consumption. Cutting small, rounded fruits and vegetables into smaller pieces reduces the potential for forming a respiratory blockage should one of the cut pieces be inhaled into an airway. However, cutting many small food items one at a time with a handheld knife is slow, may bruise or crush the food item, may expose the food item to contamination, exposes the person using the knife to a risk of a cutting injury, and adds substantial incremental expense to food preparation in a commercial food processing operation.

### SUMMARY

An example embodiment of slicing machine for cutting agricultural produce includes a conveyor plenum having a plenum top plate formed with many cutting lane vacuum ports and a dual-belt conveyor. The dual-belt conveyor includes a first conveyor belt positioned above the plenum top plate and a second conveyor belt positioned above the plenum top plate, the second conveyor belt separated laterally from the first conveyor belt, with the cutting lane vacuum ports positioned between the first and second conveyor belts. The example apparatus embodiment further includes a conveyor drive motor configured to drive the first and second conveyor belts at a same belt velocity; a water jet knife positioned to emit a water jet through a gap between the first and second conveyor belts; and a belt shaker positioned to strike the first and second conveyor belts at selected repeating intervals.

The plenum top plate of the example apparatus embodiment may further include a first conveyor belt channel formed in the plenum top plate; a second conveyor belt channel formed in the plenum top plate; and a vacuum ridge interposed between the first and second conveyor belt channels, with the cutting lane vacuum ports extending through the vacuum ridge. The vacuum ridge may extend along the dual-belt conveyor between the first and second conveyor belts.

The example slicing machine may be provided with one, and optionally more than one of a cutting lane. Each cutting lane includes one of the dual-belt conveyor, one of the water jet knife, one of the first conveyor belt channel, one of the second conveyor belt channel, and one of the vacuum ridge. A slicing machine embodiment may optionally include many cutting lane. The conveyor belts for adjacent cutting lanes may optionally be in contact with a same belt shaker. More than one belt shaker may be provided for a slicing machine with many cutting lanes.

### BRIEF DESCRIPTION OF THE DRAWINGS

FIG. 1 is a pictorial view toward the feed end and top side of an example embodiment of a slicing machine for agricultural produce.

FIG. 2 is a side view of the slicing machine embodiment of FIG. 1.

FIG. 3 is a side view of the slicing machine embodiment of FIG. 1, showing the side opposite the view of FIG. 2.

FIG. 4 is a view toward the top side of the slicing machine embodiment of FIG. 1.

FIG. 5 is a view toward the feed end of the slicing machine embodiment of FIG. 1.

FIG. 6 is a view toward the output end of the slicing machine embodiment of FIG. 1.

FIG. 7 is a pictorial view of an example of a vacuum system included in the slicing machine embodiment of FIG. 1.

FIG. 8 is a view toward the top side of the vacuum system of FIG. 1 and FIG. 7.

FIG. 9 is a view toward a side of the vacuum system of FIG. 1 and FIG. 7.

FIG. 10 is a view toward an end of the vacuum system of FIG. 1 and FIG. 7.

FIG. 11 is a cross-sectional view A-A of examples of a conveyor plenum and conveyor belts of the slicing machine embodiment of FIG. 1, illustrating an example of positions for water jet knifes above each cutting lane. A position and viewing direction for the cross-sectional view is marked by line A-A in FIG. 4.

FIG. 12 is a view toward the top side of an example of a belt shaker included in the slicing machine embodiment of FIG. 1.

FIG. 13 is a partial end view of the example belt shaker of FIG. 1 and FIG. 12.

FIG. 14 is a block diagram showing examples of components and subsystems of the example slicing machine embodiment of FIGS. 1-13.

### DESCRIPTION

A slicing machine is configured to rapidly, safely, economically, and cleanly cut large quantities of harvested agricultural produce into pieces suitable for safe human consumption. Example embodiments of the slicing machine position produce items on a dual-belt conveyor in a preferred orientation for slicing, transport the produce items along a cutting lane configured to hold the produce items securely against the dual-belt conveyor, and carry the produce items through the water jet of a water jet knife. The water jet knife divides the produce item into two pieces without damage to the dual-belt conveyor.

Embodiments of the slicing machine offer substantial cost savings for processing large quantities of food items, compared to manual cutting by a person. Food items to be cut may be loaded onto the dual-belt conveyor by a produce loader 194, for example a vibratory feeder 198, chicane ramp 196, chute, or similar loading apparatus, and may be unloaded into a bin or onto another conveyor for packaging and shipment. Food items are placed in a preferred orientation for cutting, transported along the dual-belt conveyor, and cut by the water jet knife without requiring constant monitoring by a person and without a person coming into direct contact with food items loaded onto and processed by the slicing machine. Each cutting lane on a slicing machine embodiment may be operated to slice individual food items at a rate at least two to three times faster than a skilled person cutting manually, and one slicing machine may include many slicing lanes. Furthermore, a slicing machine may be operated continuously 24 hours a day, 7 days a week, perhaps with occasional short interruptions for cleaning or maintenance.

A cyclical impact device, which may also be referred to herein as a belt shaker, periodically strikes the two separate conveyor belts in the dual-belt conveyor. Vibrations induced in the belts by the belt shaker urge the produce items loaded onto the dual-belt conveyor to settle into contact with both conveyor belts with a central axis of each produce item approximately centered along a gap between the two belts. The high-pressure water jet output from the water jet knife passes through the center of the gap between the individual belts in the dual-belt conveyor, cleanly and efficiently cutting the produce item into two approximately equal-sized pieces as the produce item passes under the water jet knife. The gap separating the individual conveyor belts in the dual-belt conveyor is positioned to allow the high-pressure water jet to pass between the two conveyor belts of the dual-belt conveyor without cutting either belt.

Slicing machine embodiments may be used to cut almost any size or kind of fruit, vegetable, or nut, but are particularly effective for cutting produce items with flexible skins and easily compressed flesh, for example but not limited to, grapes, cherry tomatoes, kumquats, olives, mulberries, strawberries, and the like. Slicing machine embodiments may alternatively be configured for slicing larger items such as melons, potatoes, apples, and so on. Produce items with an approximately spherical shape will settle into contact against both conveyor belts in the dual-belt conveyor, with the produce item approximately centered over the gap between the belts. Under the influence of the belt shaker, produce items with an approximately ellipsoidal shape, for example grapes, small tomatoes (e.g. cherry tomatoes), olives, and larger items such as melons and cucumbers, will tend to rest on the two belts with the major semi-axis of the ellipsoid approximately centered over the gap between the belts, and with the major semi-axis approximately parallel to the conveyor's direction of travel and the ellipsoid's minor semi-axis approximately perpendicular to the belt's direction of travel. A produce item landing on the input end of the dual-belt conveyor with the item's major semi-axis skew to the conveyor's direction of travel will tend to be repositioned by belt displacements from the belt shaker until the major semi-axis is parallel to the conveyor's direction of travel.

Shifting the major semi-axis of a produce item until the axis is parallel to the dual-belt conveyor's direction of travel results in a preferred shape for a cut food item. Each of the cut halves of a produce item with an ellipsoidal shape will have an approximately elliptical flat face after passing through the water jet knife. It may be more difficult for the cut food item to block a person's airway because although the rounded outer skin of the food item may seal against the walls of a respiratory airway, the food item when swallowed without chewing will tend to be oriented with the major semi-axis parallel to the walls of the respiratory airway. The outer surface rounded surface of the food item may contact and conform to the walls of the airway, but the orientation of the flat cut face encourages a gap to form between the flat face and the walls of the airway, leaving a path for respiratory airflow. Also, because the cut food item is less likely to form a seal all the way around the item's perimeter because of the interruption caused by the elliptical flat face, dislodging a stuck food item may be easier than dislodging an intact food item. Cutting the produce item parallel to the minor semi-axis may not be as effective for preventing choking; the approximately circular perimeter of the cut face may easily seal all the way around against the walls of the respiratory airway, possibly blocking respiratory airflow.

The water jet knife included in the example slicing machine embodiments provides several advantages over metal or ceramic cutting tools with sharp edges. The water jet knife cuts with a thin stream of clean, high-pressure water. Water jet knives are effective for cutting steel and other hard materials and can easily cut fruits and vegetables without tearing, compressing, bruising, crushing, or heating the item being cut. Unlike some cutting tools, a water jet knife does not produce airborne dust or food particles during cutting. Sterile water can be used to form the water jet, eliminating the washing and sanitizing required of a metal or ceramic blade. Unlike a blade with a sharp edge, there is no risk of a cutting injury to equipment operators or maintenance personnel unless the water jet is being output from the knife. Unlike a blade with a sharp edge, the water jet knife never needs sharpening.

In addition to the dual-belt conveyor and water jet knife, a slicing machine embodiment includes a vacuum system to hold produce items against the dual-belt conveyor during transport along the conveyor and during cutting. The vacuum system, parts of which lie directly beneath and along the segment of the dual-belt conveyor for carrying produce items to be cut, prevents the produce items from being ejected from the conveyor by the belt shaker and holds the produce items securely against the conveyor during cutting by the water jet knife. The vacuum system further collects mist and droplets resulting from operation of the water jet knife, from washing operations, and liquid carried on the surface or released from the inside of the produce items being cut. The vacuum system is effective for preventing water accumulation on the slicing machine and for reducing the occurrence of liquid reservoirs that could support the growth of biological contaminants such as microbes, fungi, and viruses.

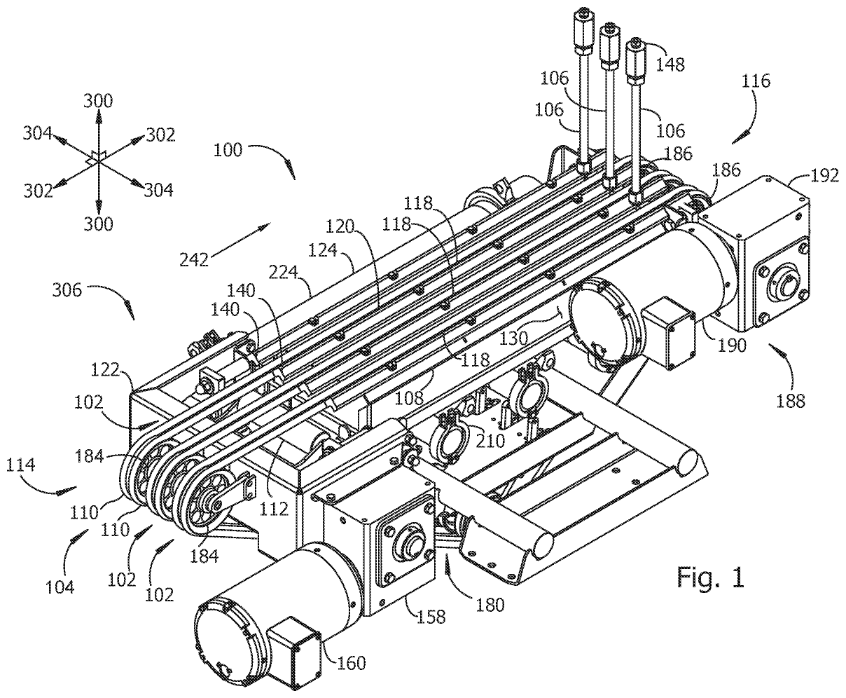

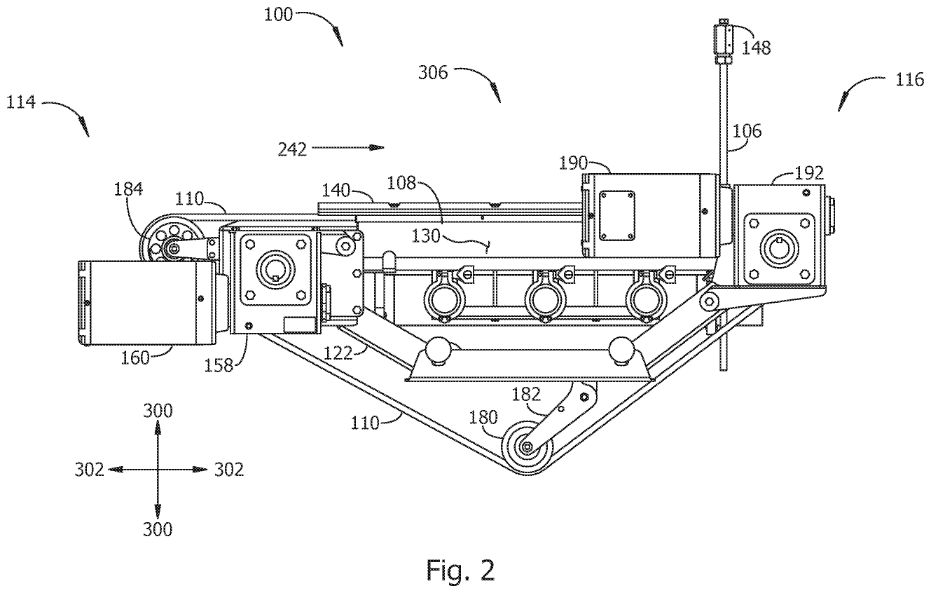

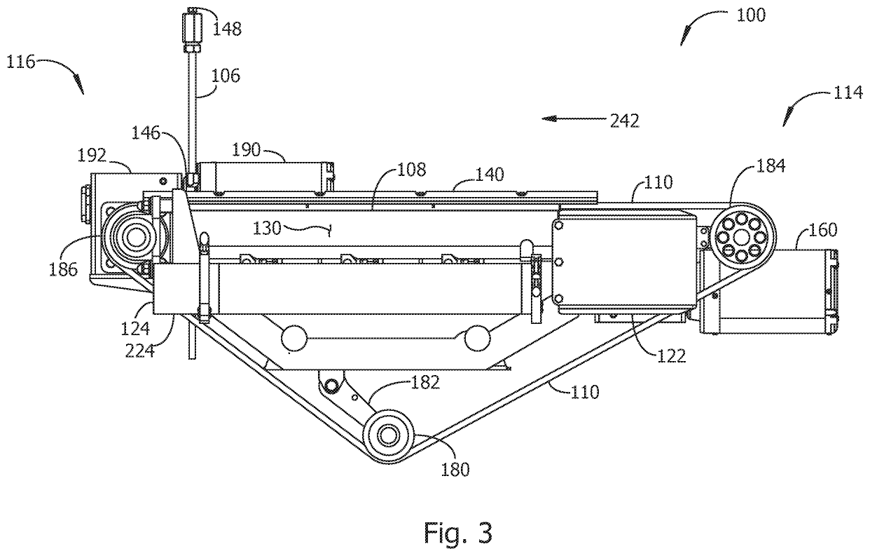

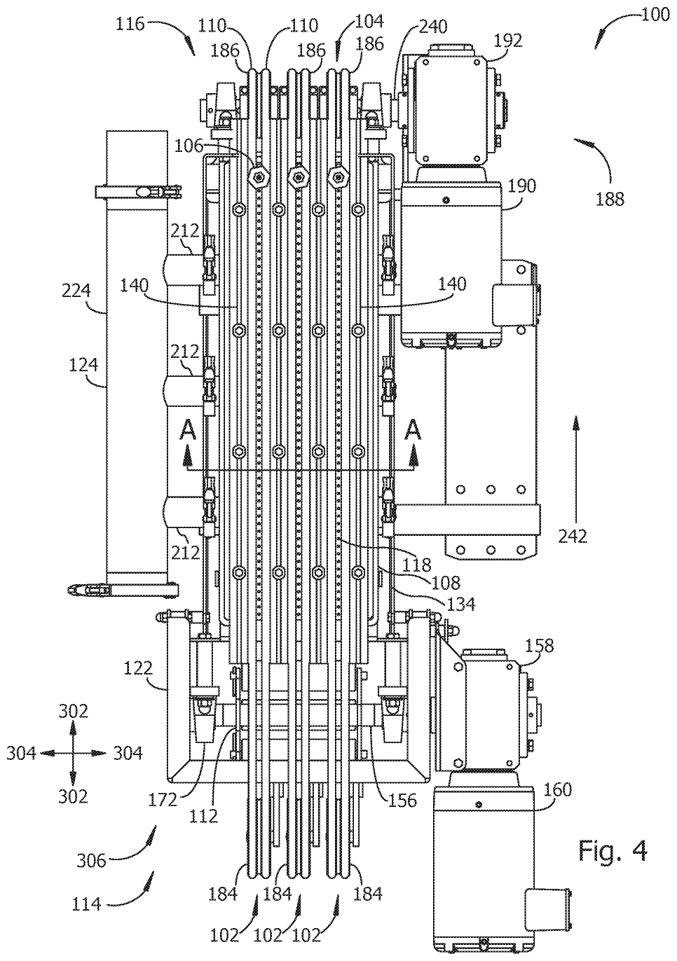

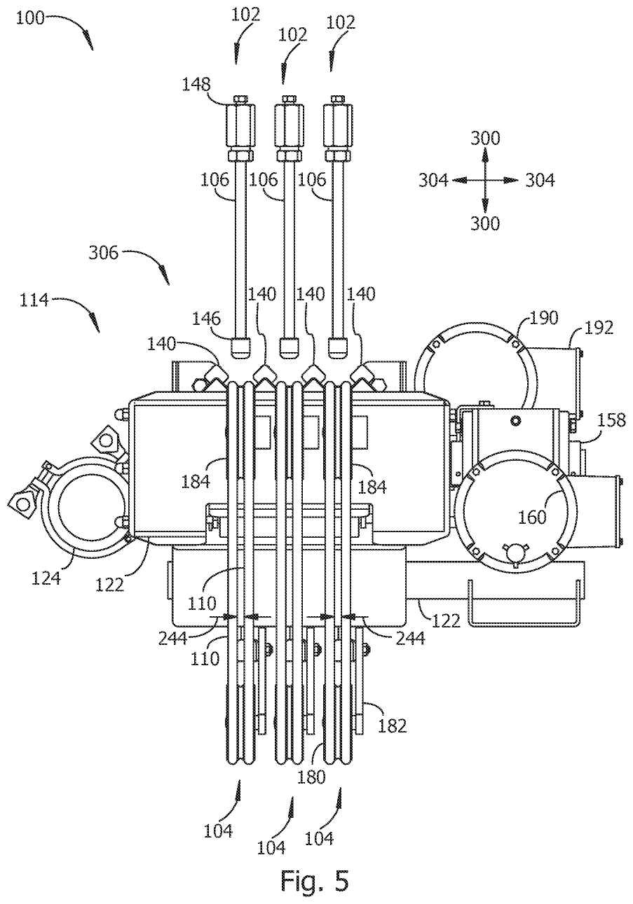

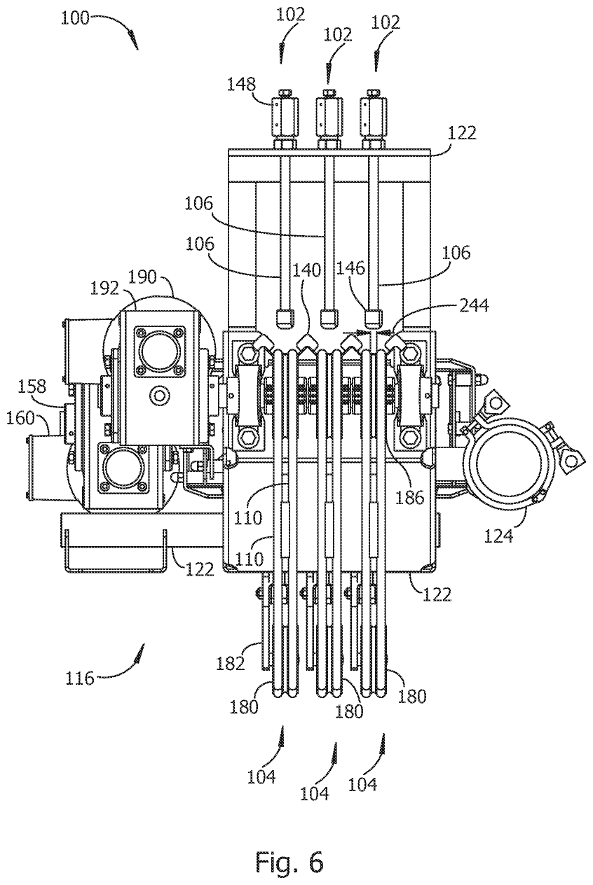

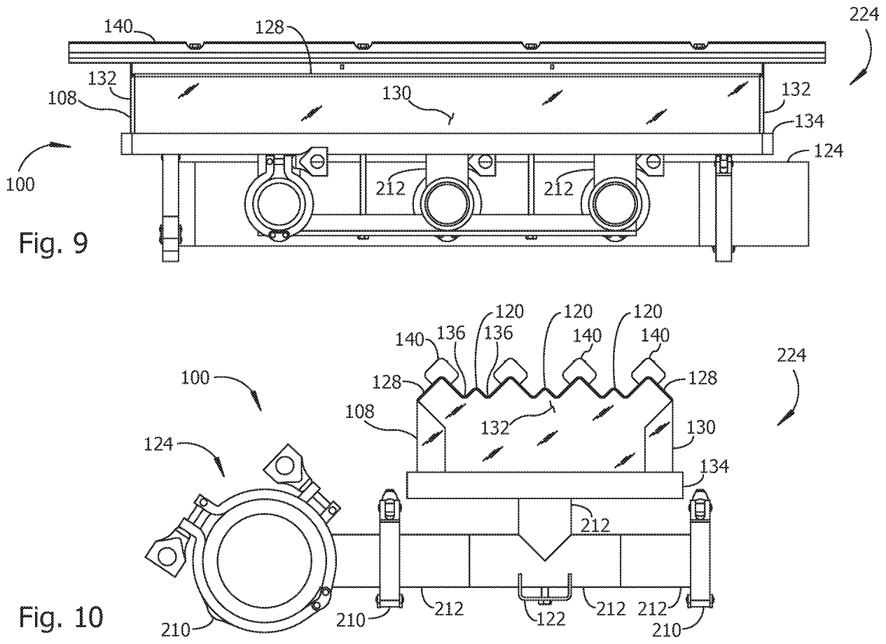

An example embodiment of a slicing machine is shown from different viewing directions in FIGS. 1, 2, 3, 4, 5, and 6. Some details of components and subsystems included in the example slicing machine embodiment of FIGS. 1-6 are shown in FIGS. 7-14. As shown in the figures, the example slicing machine 100 includes a dual-belt conveyor 104 having a feed end 114 where food items to be sliced may be placed on the dual-belt conveyor, an output end 116 from which cut food items may be removed, a water jet knife 106 for slicing the food items carried on the dual-belt conveyor, a belt shaker 112 for encouraging a preferred orientation of the food items on the dual-belt conveyor, a vacuum system 224 for holding food items onto the dual-belt conveyor and for removing water from food items and from the slicing machine 100, and a support frame 122 to which other slicing machine components are attached. The dual-belt conveyor 104, water jet knife 106, belt shaker 112, vacuum system 224, and support frame 122 cooperate with one another to rapidly, accurately, safely, and hygienically cut food items into smaller pieces, with each of the subsystems (104, 106, 112, 224, 122) improving the performance of the others.

The dual-belt conveyor 104, water jet knife 106, and parts of the vacuum system 224 of the slicing machine 100 are arranged into at least one cutting lane 102. A food item to be cut is place at the feed end 114 of the cutting lane and is transported across the top side 306 of the slicing machine 100 to the output end 116 of the cutting lane by the dual-belt conveyor. The example slicing machine 100 in the figures has three cutting lanes 102. An embodiment of a slicing machine 100 may have as few as one cutting lane or may alternatively have many cutting lanes, for example 10 cutting lanes, 20 cutting lanes, or more. The example slicing machine embodiment 100 in the figures is readily scalable to support high production capacity.

The example dual-belt conveyor 104 includes a first conveyor belt 110 and a second conveyor belt 110 separated from one another in a transverse direction 304 by a belt gap 244. Each of the conveyor belts 110 are formed as a closed loop from a flexible, food-safe polymer material capable of withstanding extended contact with hot water, steam, and sanitizing agents commonly used in food processing facilities. Food items to be cut rest against the first and second conveyor belts over the belt gap 244. The belt gap 244 is preferably narrow enough that a sliced food item will not fall through the gap. A water jet emitted from the water jet knife passes between the first and second conveyor belts through the belt gap 244 without directly impinging on either conveyor belt in the cutting lane 102.

The first and second conveyor belts 110 pass around a drive pulley 186, an idler pulley 184, and optionally around a tensioning pulley 180 coupled to a tension arm 182. The tension arm 182, rotatably coupled to the support frame 122, and the tensioning pulley, rotatably coupled to tension arm 182, remove slack from the conveyor belts 110 and hold the conveyor belts 110 into firm contact with the drive pulley 186 and idler pulley 184. For a slicing machine with multiple cutting lanes, the drive pulleys 186 may alternatively be combined into a single pulley or roller, optionally with separate circumferential channels for each conveyor belt. Idler pulleys 186 and/or tensioning pulleys 180 may similarly be combined for slicing machines with multiple cutting lanes.

The drive pulleys 186 are part of a conveyor drive 188. The conveyor drive 188 moves the dual-belt conveyor in a direction 242 from the feed end 114 to the output end 116 along the top side 306 of the slicing machine 100. Both conveyor belts 110 in the dual-belt conveyor 104 preferably move in the same direction of travel 242 at the same belt velocity. The drive pulleys are attached to a conveyor drive shaft 240 driven in rotation by a conveyor motor 192 and conveyor transmission 192. The conveyor transmission 192 reduces the output rotation rate of the conveyor motor to a speed suitable for moving the dual-belt conveyor without ejecting food items from the conveyor or causing food items to roll along the conveyor. A slicing machine 100 may optionally use a stepper motor capable of a wide range of rotation rates for the conveyor motor 192 and may omit the conveyor transmission 192.

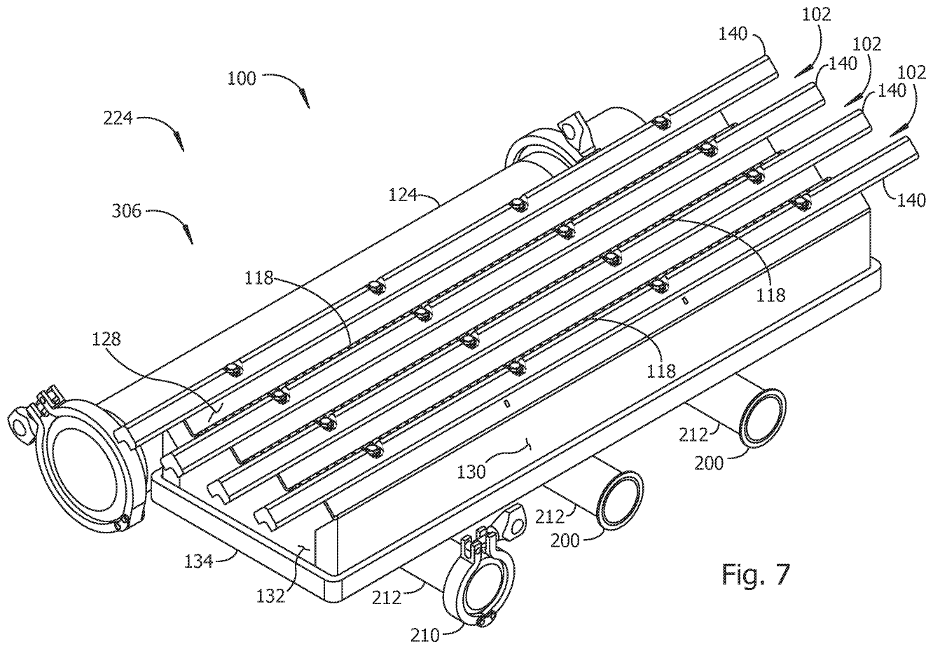

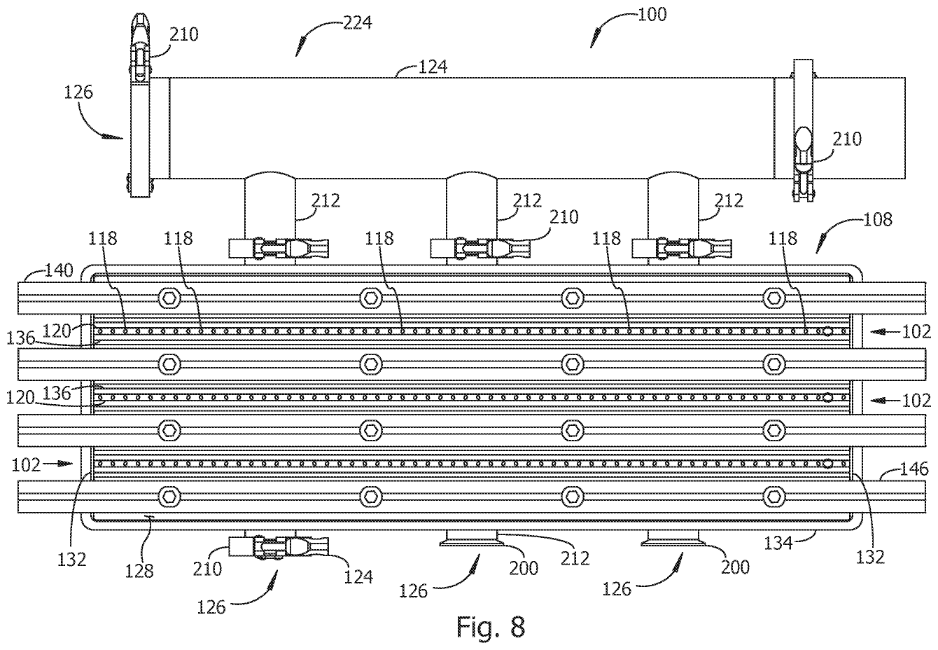

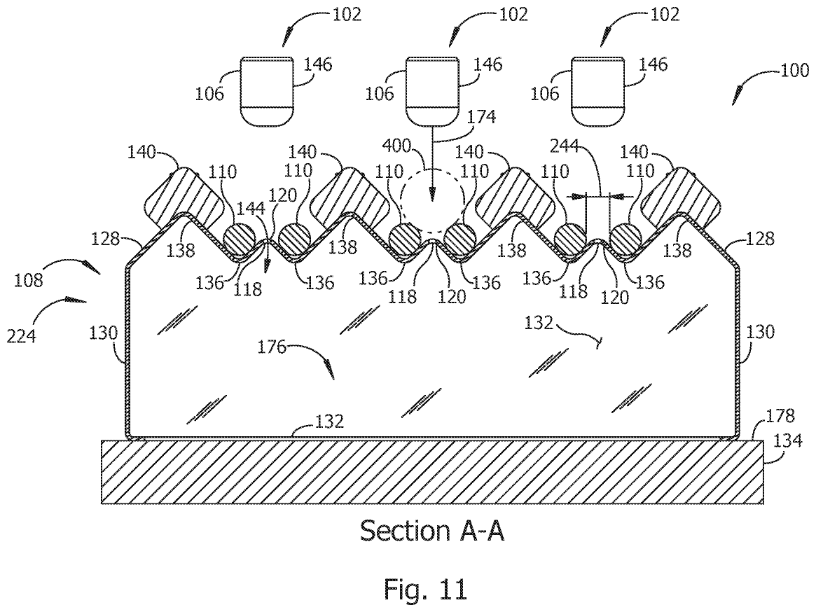

The segment of the dual-belt conveyor 104 configured for carrying food items on the top side 306 of the slicing machine 100 passes close above the top plate 128 of a conveyor plenum 108. Many vacuum ports 118 are formed in the conveyor plenum top plate 128. As shown in the examples of FIGS. 7-8 and the cross-sectional view A-A in FIG. 11, the vacuum ports 118 are positioned longitudinally at close intervals along the top plate 128, in close proximity to the conveyor belts 110, and directly underneath the longitudinal belt gap 244 between the conveyor belts. A strong air flow induced by a vacuum pump operating to reduce air pressure in the conveyor plenum 108 holds food items directly above the vacuum ports 118 in sufficiently firm contact with the dual-belt conveyor 104 to prevent the food items from shifting position against the conveyor belts 110.

Examples of some details of the vacuum system are shown in FIGS. 7-11. The conveyor plenum 108 is formed with two side walls 130 and two end walls 132 attached to the top surface 178 of a base plate 134. The conveyor plenum top plate 128 is attached to the side walls 130 and end walls 132. An interior void space 176 formed between the base plate, top plate, side walls, and end walls of the conveyor plenum is in fluid communication with a vacuum manifold 124 and one or more vacuum ports 126 through intervening vacuum lines 212 passing through the base plate 134. Connection flanges 200 and vacuum connectors 210 on the vacuum lines and vacuum manifold are provided for connection of vacuum hoses and a vacuum pump 226. Water droplets and water vapor entering the vacuum system 224 may be recovered by a water recovery system 230 including a water separator 232 and a water pump 234 coupled to the vacuum system 224. The number of vacuum lines 212 in fluid communication with the interior void space 176 of the conveyor plenum 108 and the size of the vacuum manifold 124 are preferably selected to maintain a sufficiently strong airflow through the many vacuum ports 118 formed in the conveyor plenum top plate 128 to prevent food items from falling or bouncing off the dual-belt conveyor.

The conveyor plenum top plate 128 includes features for positioning the conveyor belts 110 relative to the vacuum ports 118 and for positioning food items to be cut on the dual-belt conveyor 104. As shown in the examples of FIGS. 10-11, the conveyor plenum top plate is attached to, and optionally formed integrally with, one or more of the side walls 130 and end walls 132. Although the conveyor plenum top plate 128 may optionally be formed as a flat plate, in the illustrated example the top plate is formed with a vacuum ridge 120 for each cutting lane 102. The vacuum ridge 120 extends in a longitudinal direction 302 from near the end plate 132 at the feed end 114 of the conveyor plenum to the opposite end plate 132 at the output end 116. Vacuum ports 118 formed in the vacuum ridge 120 establish a path for airflow from the outside atmosphere to the void space 176 in the interior of the conveyor plenum.

Two conveyor belt channels 136 may be formed longitudinally along and on opposite lateral sides of each vacuum ridge 120. Each conveyor belt channel 136 is positioned to carry one of the conveyor belts 110 of the dual-belt conveyor 104 with the individual belts 110 separated from one another in a transverse direction 304 by the belt gap 244. As suggested in the example of FIG. 11, a produce item 400 preferably rests against both conveyor belts 110 in close proximity to the vacuum ports 118 formed along the vacuum ridge 120. A produce item 400 may also be referred to herein as a food item. The vacuum ridge 120 brings the food items in close proximity to the vacuum ports between the conveyor belts 110, improving the holding power of the airflow 144 passing through the vacuum ports 118 to hold the food item in a stable position on the dual-belt conveyor.

A longitudinal guide bar ridge 138 may optionally be formed adjacent each conveyor belt channel 136. The guide bar ridge 138 and conveyor belt channel 136 cooperate to hold each conveyor belt 110 in a preferred position relative to the vacuum ports 118 and water jet output nozzle 146 of the water jet knife 106, with the water jet following a path 174 passing through the belt gap 244 between the conveyor belts 110. The guide bar ridge further prevents food items on the dual-belt conveyor from bouncing or rolling off the conveyor. A longitudinal guide bar 140 may optionally be attached to, or alternatively replace, each guide bar ridge 138. The guide bars 140 may be made from a food-safe polymer material with a slippery, wear-resistant surface capable of withstanding extended exposure to liquid water, steam, and sanitizing agents.

The belt shaker 112 is preferably positioned between feed end 114 of the dual-belt conveyor and the end of the line of vacuum ports 118 in the conveyor plenum top plate 128 closest to the feed end. The belt shaker 112 is rotatably coupled to the support frame 122 below the segment of the dual-belt conveyor between the idler pulleys and the conveyor belt plenum. The belt shaker 112 is configured to strike the individual conveyor belts 110 of the dual-belt conveyor 104, deflecting the belts in a vertical direction 300 at regular intervals and causing a series of impact transient to travel along each conveyor belt. The impact transients urge each food item to settle into contact with both conveyor belts 110.

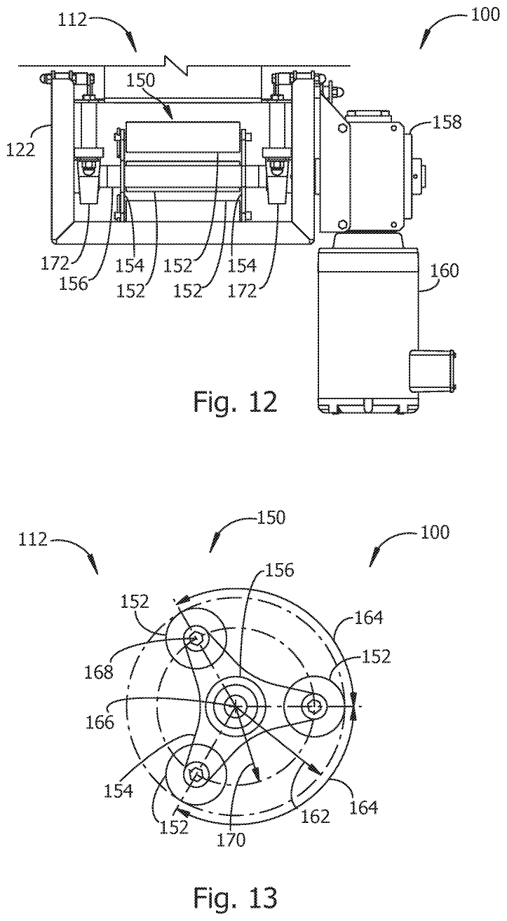

The belt shaker example of FIGS. 12-13 includes a roller assembly 150 attached to a roller assembly drive shaft 156. The roller assembly drive shaft 156 may be rotatably coupled to the support frame 122 by one or more drive shaft bearings 172. The roller assembly drive shaft 156 is driven in rotation by a transmission 158 and a motor 160. A slicing machine embodiment may optionally use a stepper motor for driving the belt shaker and may optionally eliminate the belt shaker transmission 158. A roller 152 is rotatably coupled to an end bracket 154 attached to the roller assembly drive shaft 156. A second end bracket 154 may be rotatably coupled to the roller 152 and attached to the roller assembly drive shaft 156.

The example belt shaker 112 shown in the patent figures may be referred to as a rotary thumper. Alternative embodiments of a slicing machine 100 may replace the rotary thumper with a linear solenoid positioned to strike one or more of the conveyor belts 110 in the dual-belt conveyor 104, a rotary solenoid, a motor with an eccentric rotating weight, or another means of inducing a repetitive vibration or displacement of the conveyor belts in the region between the feed end 114 and the vacuum ports 118.

The radial separation distance 170 between the center of rotation 168 of the roller 152 and the center of rotation 166 of the roller assembly drive shaft 156 is preferably chosen to cause the outer radius 162 of the roller assembly 150 to be slightly greater than the vertical separation distance from the roller assembly drive shaft to the conveyor belts 110, thereby causing the roller 152 to impact the conveyor belts 110 each time the roller assembly drive shaft completes one revolution. The number of impacts between the roller assembly 150 and the conveyor belts 110 may be increased by adding additional rollers 150. The angular separation distance 164 between rollers and the rotational speed of the roller assembly drive shaft may be used to set the timing between impact transients. The example belt shaker 112 shown in the figures includes three rollers in the roller assembly 150, providing three impact transients against the conveyor belts 110 for each revolution of the roller assembly drive shaft 156.

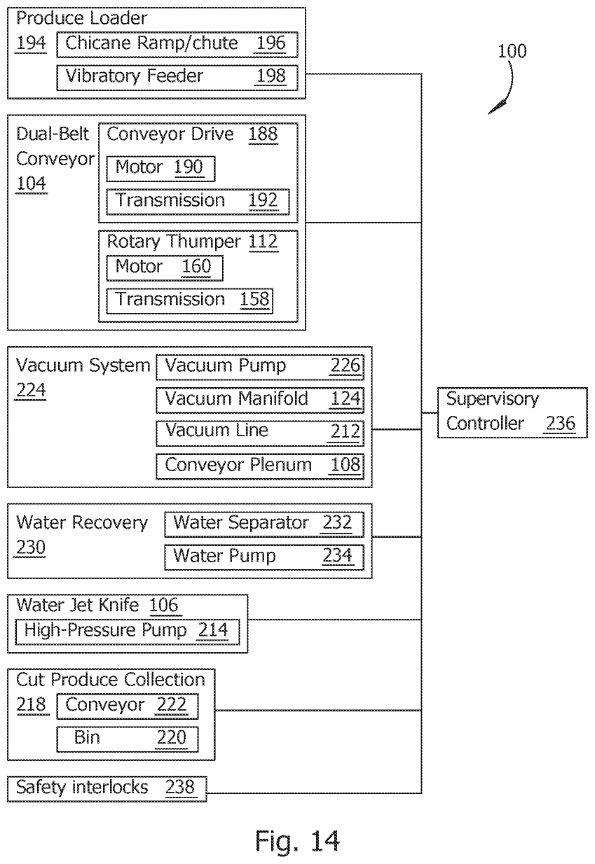

FIG. 14 shows an example of a supervisory control system included with a slicing machine 100. A supervisory controller 236, for example an industrial programmable controller, a microprocessor, and/or a microcomputer may be located in an enclosure mechanically attached to the support frame 122, or alternatively placed in a separate enclosure connected for signal communication with other parts of the slicing machine 100. The supervisory controller may, for example, monitor and/or control a produce loader to place items to be cut at the feed end of each cutting lane. The produce loader may include a chicane ramp 196, a chute, and/or a vibratory feeder 198 configured to tumble produce items to be cut through a curved or tapered channel to encourage the produce items to land on the dual-belt conveyor with a major semi-axis of the produce item approximately parallel to the conveyor's direction of travel.

The supervisory controller 236 may be configured to monitor and control the speed of motion of the dual-belt conveyor 104, for example controlling the motor 190 and optionally the transmission 192 of the conveyor drive 188 and the motor 160 and transmission of the belt shaker 112 to position produce items on the dual-belt conveyor for cutting, detect the presence or absence of a produce item to be cut, and so on.

The vacuum system 224 may optionally be monitored and controlled by the supervisory controller. For example, the supervisory controller may control the vacuum pump 226 to establish a preferred air pressure measured in the vacuum manifold 124, one or more of the vacuum lines 212, and/or the vacuum plenum 108.

The supervisory controller may monitor temperature, humidity, and liquid water levels in the slicing machine 100 to determine when to operate a water recovery system. The water recovery system 230 may include a water separator 232 coupled to the vacuum system 224 and a water pump 234 coupled to the water separator.

The supervisory controller 236 may be connected for signal communication with a high-pressure water pump 214 for controlling the force and/or volume of water emitted as a water jet from the water jet knife 106. The supervisory controller may selectively operate the water jet knife continuously or in short bursts each time a produce item is detected under the water jet knife.

After being cut by the water jet knife 106, cut produce may be transferred by the dual-belt conveyor 104 under the control of the supervisory controller to a cut produce collection device 218, for example a conveyor 222 or a bin 220.

The supervisory controller 236 may be configured to monitor the slicing machine 100 for safe operation, for example by monitoring safety interlocks 238 designed to prevent injury to nearby persons and by shutting down parts of the slicing machine 100, for example the dual-belt conveyor 104 and/or water jet knife 106, when a safety interlock 238 is actuated.

In the example of a slicing machine 100 shown in the figures, the example of a water jet knife 106 is shown above the conveyor plenum top plate 128, with the water jet nozzle 146 positioned to direct a water jet vertically downward toward the dual-belt conveyor. A high pressure water pump couples to the water jet 102 through a fluid connector 148. A water jet for cutting food items carried on the dual-belt conveyor 104 for each cutting lane 102 is emitted from a water jet output nozzle 146. In an alternative embodiment of the slicing machine water, the water jet knife 106 is positioned with its output nozzle 146 below the dual-belt conveyor and the water jet nozzle 146 oriented to direct a water jet vertically upward through the belt gap 244 between the conveyor belts 110 and onto a produce item 400 to be cut.

In the example of a slicing machine 100 shown in the figures, the idler pulleys 184 are rotatably coupled to the support frame 122 near the feed end 114 and the drive pulleys 186 and other parts of the conveyor drive 188 are attached to the support frame near the output end. In an alternative embodiment of the slicing machine 100, the conveyor drive 188 may be positioned near the feed end 114 and the idler pulleys may be positioned near the output end 116.

Unless expressly stated otherwise herein, ordinary terms have their corresponding ordinary meanings within the respective contexts of their presentations, and ordinary terms of art have their corresponding regular meanings.

What is claimed is:

1. An apparatus, comprising:
a conveyor plenum comprising a plenum top plate formed with a plurality of cutting lane vacuum ports;
a dual-belt conveyor comprising:
a first conveyor belt positioned above said plenum top plate; and
a second conveyor belt positioned above said plenum top plate, said second conveyor belt separated laterally from said first conveyor belt, said plurality of cutting lane vacuum ports positioned between said first and second conveyor belts;
a water jet knife positioned to emit a water jet through a gap between said first and second conveyor belts; and
a belt shaker positioned to strike said first and second conveyor belts at selected repeating time intervals.

2. The apparatus of claim 1, further comprising a vacuum manifold in fluid communication with said conveyor plenum and said plurality of cutting lane vacuum ports.

3. The apparatus of claim 2, further comprising a vacuum pump coupled to said vacuum manifold.

4. The apparatus of claim 2, further comprising a water separator coupled to said vacuum manifold.

5. The apparatus of claim 1, said plenum top plate further comprising:
a first conveyor belt channel formed in said plenum top plate;
a second conveyor belt channel formed in said plenum top plate; and
a vacuum ridge interposed between said first and second conveyor belt channels, said plurality of cutting lane vacuum ports extending through said vacuum ridge.

6. The apparatus of claim 5, wherein said vacuum ridge extends along said dual-belt conveyor between said first and second conveyor belts.

7. The apparatus of claim 5, further comprising:
a cutting lane comprising:
said dual-belt conveyor;
said water jet knife;
said first conveyor belt channel;
said second conveyor belt channel; and
said vacuum ridge; and
a second of said cutting lane on said plenum top plate.

8. The apparatus of claim 1, further comprising:
a first guide bar extending longitudinally along said plenum top plate adjacent said first conveyor belt; and
a second guide bar extending longitudinally along said plenum top plate adjacent said second conveyor belt.

9. The apparatus of claim 8, wherein said first and second conveyor belts and said plurality of cutting lane vacuum ports are interposed between said first and second guide bars.

10. The apparatus of claim 1, further comprising:
a first drive pulley coupled to a conveyor drive motor, said first conveyor belt passing around said first drive pulley; and
a second drive pulley coupled to said conveyor drive motor, said second conveyor belt passing around said second drive pulley,
wherein said first drive pulley and said second drive pulley are positioned to separate said first conveyor belt from said second conveyor belt by said gap.

11. The apparatus of claim 10, further comprising:
a first idler pulley positioned at an opposite end of said conveyor plenum from said first drive pulley, said first conveyor belt passing around said first idler pulley; and
a second idler pulley positioned at an opposite end of said conveyor plenum from said second drive pulley, said second conveyor pulley passing around said second idler pulley.

12. The apparatus of claim 1, said belt shaker comprising:
a belt shaker drive motor;
a roller assembly drive shaft rotatably coupled to said belt shaker drive motor;
a first end bracket attached to said roller assembly drive shaft;
a roller rotatably attached to said first end bracket, said roller separated from said drive shaft by a radial distance sufficient to cause contact between said roller and said first and second conveyor belts; and
a second end bracket rotatably coupled to said roller and attached to said roller assembly drive shaft at an end of said roller opposite said first end bracket.

13. The apparatus of claim 12, further comprising a second roller rotatably attached to said first and second end brackets.

14. The apparatus of claim 13, further comprising a third roller rotatably attached to said first and second end brackets.

15. The apparatus of claim 14, wherein said roller, said second roller, and said third roller are spaced at equal angular intervals around said roller assembly drive shaft.

16. An apparatus, comprising:
a conveyor plenum comprising a plenum top plate formed with a plurality of cutting lane vacuum ports, said plenum top plate comprising:
a first conveyor belt channel formed in said plenum top plate;
a second conveyor belt channel formed in said plenum top plate; and
a vacuum ridge interposed between said first and second conveyor belt channels, said plurality of cutting lane vacuum ports extending through said vacuum ridge;
a dual-belt conveyor comprising:
a first conveyor belt positioned above said plenum top plate; and
a second conveyor belt positioned above said plenum top plate, said second conveyor belt separated laterally from said first conveyor belt, said plurality of cutting lane vacuum ports positioned between said first and second conveyor belts;
a conveyor drive motor configured to drive said first and second conveyor belts at a same belt velocity;
a water jet knife positioned above said first and second conveyor belts and further positioned to emit a water jet through a gap between said first and second conveyor belts; and
a belt shaker positioned to deflect and release said first and second conveyor belts at least once per revolution of said belt shaker, said belt shaker comprising:
a belt shaker drive motor;
a roller assembly drive shaft rotatably coupled to said belt shaker drive motor;
a first end bracket attached to said roller assembly drive shaft;
a roller rotatably attached to said first end bracket, said roller separated from said drive shaft by a radial displacement sufficiently large to cause contact between said roller and said first and second conveyor belts; and
a second end bracket rotatably coupled to said roller and attached to said roller assembly drive shaft at an end of said roller opposite said first end bracket.

17. The apparatus of claim 16, further comprising a second roller rotatably attached to said first and second end brackets.

18. The apparatus of claim 17, further comprising a third roller rotatably attached to said first and second end brackets.

19. The apparatus of claim 18, wherein said roller, said second roller, and said third roller are spaced at equal angular intervals around said roller assembly drive shaft.

20. The apparatus of claim 16, further comprising:
a cutting lane, comprising:
said dual-belt conveyor;
said water jet knife;
said first conveyor belt channel;
said second conveyor belt channel; and
said vacuum ridge; and
another of said cutting lane.
